(19) United States
(12) Patent Application Publication
(10) Pub. No.: US 2005/0082438 A1
(43) Pub. Date: Apr. 21, 2005

(54) Swimming pool podium

(76) Inventor: Jaime Morral Gispert, Polinya (ES)

Correspondence Address: JORDAN AND HAMBURG LLP, 122 EAST 42ND STREET, SUITE 4000, NEW YORK, NY, 10168, US

(21) Appl. No.: 10/912,711

(22) Filed: Aug. 5, 2004

(30) Foreign Application Priority Data
Oct. 16, 2003 (ES) 200302421

(51) Int. Cl. F16M 11/00

(52) U.S. Cl. 248/100

(57) ABSTRACT

A swimming pool podium comprises a fixedly arranged grip fitted onto each of the two side members of a platform, each of the grips comprising an angular handle whose gripping length extends towards the front edge of the platform.

### FIELD OF THE INVENTION

As is well known, at many swimming pools, and mainly at those being used for competitions, podiums are installed near the edge from which the swimmers plunge into the water. Such podiums comprise a base and an upper platform on which the swimmer takes a position in order to plunge into the water, the podium being frontally provided with a handhold.

In order to more comfortably allow the swimmer to grippingly take a position on the podium before plunging into the water and to thus obtain a better impetus at the start, the applicant fitted to the podium two lateral, articulated grips fitted onto the platform in such a way that they are apt to be locked in different positions. Such grips are the subject of Utility Model No. ES-1 055 819 (U 200300679).

Such articulated grips have a complex makeup thereby increasing the price of the podium.

### BRIEF SUMMARY OF THE INVENTION

It is the object of this invention to provide the podiums with fixedly arranged grips which, due to their structural simplicity, provide a notable reduction in the manufacturing cost for the podium.

These fixedly arranged grips are made up by an angular handle being fitted onto each side of the platform with the gripping length extending towards the front edge of the latter.

These and other features will be best made apparent by the following detailed description, the understanding of which will be made easier by the accompanying drawings showing a practical embodiment and being cited only by way of example but not limiting the scope of the present invention.

### DESCRIPTION OF THE DRAWINGS

FIG. 1 illustrates in a perspective view a podium provided with two fixedly arranged grips according to one embodiment of the invention;

FIG. 2 represents this podium in a front elevation; and

FIGS. 3 and 4 show the podium a side elevation (without the side plate being provided on it) with the platform in a horizontal and in a tilted position, respectively.

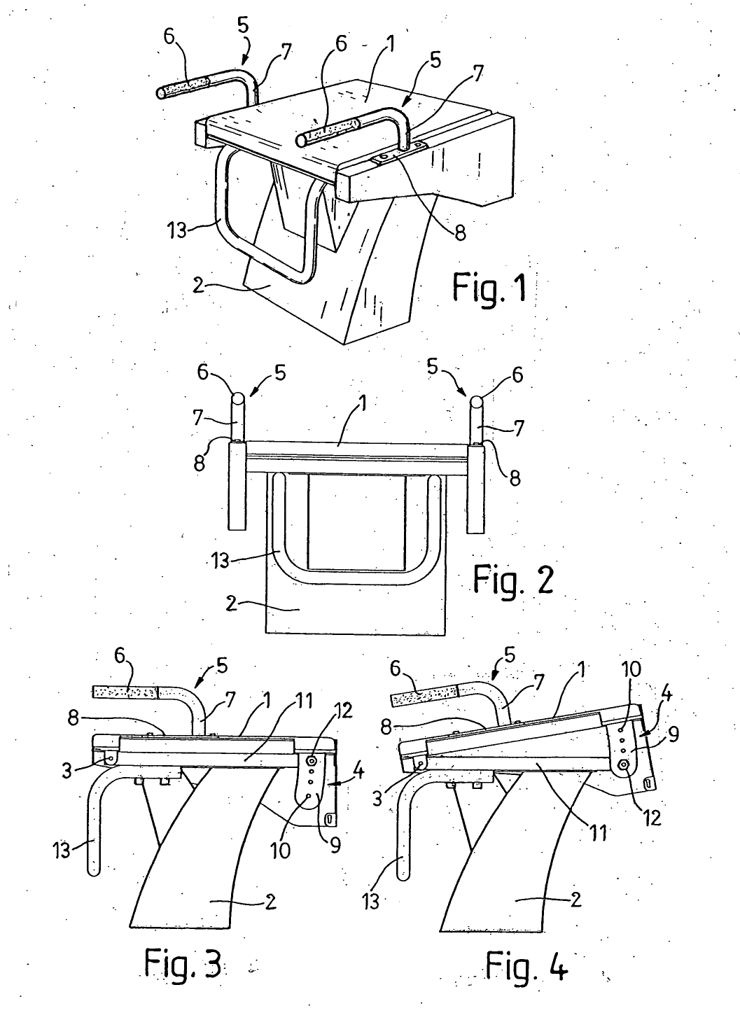

### DETAILED DESCRIPTION OF PREFERRED EMBODIMENTS

According to the drawings the podium comprises a platform 1 arranged on a base 2, the platform being frontally linked to the base in a pin-jointed connection by means of a pin 3 whereas in its rearward portion the platform 1 is provided with means 4 operable to lock the tilted position being chosen for it.

In this podium a fixedly arranged grip 5 is fitted onto each side of the platform 1.

The grip is made up by an angular, metallic handle whose gripping length 6 extends towards the front edge of the platform 1 and is provided with an antislip knurled region. The upright length 7 of the handle is integral with a strip 8 which is fixed by means of screws onto the side members of the platform 1.

Each of the means 4 is operable to lock the different tilted positions of the platform 1 and comprises a side lug 9 (FIGS. 3 and 4) integral with the rearward portion of the platform, such lugs being provided with a number of holes 10 arranged in an arcuate arrangement, and in juxtaposition of a hole being provided in the rearward portion of the plate 11 to which the platform is frontally linked in a pin-jointed connection, the latter hole being concealed in the drawings by the lugs 9 and being selectively put in register with the holes 10, the selected position being locked by means of bolts 12 extending through one of the holes 10 and through the hole being provided in the plate 11, the corresponding nuts being threadingly engaged with said bolts.

The platform 1 comprises means (not shown) operable to allow longitudinal adjustment on the base, the podium being complemented with a conventional handhold.

The invention can essentially be put into practice in other embodiments, only in detail differing from that having been set forth above only by way of example.

1. A swimming pool podium having a platform comprising two side members on the platform, and a fixedly arranged grip fitted onto each of the two side members.

2. A swimming pool podium according to claim 1, wherein the platform has a front end and wherein each of the grips comprises an angular handle whose gripping length extends towards the front end of the platform.

3. A swimming pool podium according to claim 1, wherein each of the grips has an L-shaped configuration.

4. A swimming pool podium according to claim 1, wherein said platform has a front end, each of said grips extending as a cantilever toward the front end of said platform.

5. A swimming pool podium according to claim 1, wherein said side members have a front and a rear, and further comprises an adjustable structure for adjusting the position of the grips on said side member relative to the front and rear of the side members.

6. A swimming pool podium according to claim 1, further comprising an actuable structure for adjusting the angular position of said platform relative to the podium.
